(19) United States
(12) Patent Application Publication
(10) Pub. No.: US 2024/0351444 A1
(43) Pub. Date: Oct. 24, 2024

(54) CURRENT COLLECTOR FOR AN ELECTRICALLY OR HYBRID-ELECTRICALLY POWERED ROAD VEHICLE

(71) Applicant: Siemens Mobility GmbH, München (DE)

(72) Inventors: Florian Bühs, Berlin (DE); Holger Schererz, Rehfelde (DE)

(21) Appl. No.: 18/290,901

(22) PCT Filed: Jun. 29, 2022
(86) PCT No.: PCT/EP2022/067856

§ 371 Date: Jan. 22, 2024

(30) Foreign Application Priority Data
Jul. 21, 2021 (DE) 10 2021 207 821.4

(51) Int. Cl. B60L 5/24; B60L 5/19; B60L 5/28; B60L 5/36; B60L 50/53

(52) U.S. Cl. CPC B60L 5/24; B60L 5/19; B60L 5/28; B60L 5/36; B60L 50/53

(57) ABSTRACT

A current collector for an electrically powered vehicle has an articulated supporting rod supporting a rocker assembly and a lifting drive. The supporting rod is a pantograph with a lower arm and an upper arm and an elbow joint. The rocker assembly has a rocker frame with mutually parallel upper and lower transverse beams. The beams are connected centrally by a center strut and on each end side by a lateral strut on swivel joints. The upper arm is connected on the contact wire side to the center strut via a rocker joint. The contact strips of the two contact poles are supported on the rocker frame symmetrically with respect to the center strut. In this way a current collector is provided by which, with a simpler construction, a consistent contact force can be achieved between contact strips and contact wires of the overhead line system.

The invention relates to a current collector for an electrically or hybrid electrically powered road vehicle according to the preamble of claim 1.

For the transport of goods or the conveyance of persons, electric traction units with current collectors for traction supply from a track-side overhead line system in rail transport are sufficiently well known. For some time, however, non-track-bound traction units, in particular heavy commercial vehicles for road traffic, with a diesel-electric drive and with current collectors for feeding electrical energy from an overhead line system have also been known. Due to the rubber tires of such road vehicles, two-pole overhead line systems are required for electrified traffic lanes, and contact wires designed as supply and return conductors span this traffic lane. Correspondingly, the current collector must also be of two-pole design.

Such a generic current collector is known, for example, from patent application DE 10 2017 203 046 A1. It comprises an articulated supporting rod which, on the contact wire side, supports a rocker assembly with at least one contact pole per contact pole and, on the vehicle side, has a base joint for support on the road vehicle. The current collector further comprises a lifting drive which is coupled to the supporting rod in such a way that the contact strips can be raised from a lower storage position to an upper contact position.

For each contact pole, the supporting rod of the known current collector has a separate upper arm, and accordingly the rocker assembly has its own rocker with contact strips for each contact pole, each of the two upper arms supporting one of the rockers. The two upper arms are connected to the lower arm via a common elbow joint but can be rotated independently of one another against the lower arm, so that the two rockers which are electrically insulated from one another can assume different vertical positions. As a result, unevenness of the roadway, rolling of the road vehicle and contact wires of different heights can be compensated in order to keep the contact forces between contact strips and contact wires as constant as possible during operation of the road vehicle and to minimize contact losses. The known current collector has many and complicated individual parts and requires precise and complex adjustment before and during integration into a road vehicle.

The object of the invention is therefore to provide a current collector of the type described at the outset, with which a consistent contact force between contact strips and contact wires of the overhead line system can be achieved with a simpler design.

The object is achieved according to the invention by a generic current collector with the features specified in the characterizing part of claim 1. Accordingly, the supporting rod is designed like a pantograph and comprises one lower arm and—in contrast to the current collector described at the outset—also only one upper arm, which is connected to the lower arm via an elbow joint. The rocker assembly has a rocker frame with an upper transverse beam and a lower transverse beam, which are arranged parallel or almost parallel to one another. The upper transverse beam is connected to the lower transverse beam centrally by a center strut and on both sides by a lateral strut. The center strut and lateral struts are arranged parallel or almost parallel to one another and have swivel joints at the six connection points, each having a rotational degree of freedom defined by an axis of rotation. The six axes of rotation run parallel to one another, so that the rocker frame defines a parallelogram or almost a parallelogram with fixed lateral lengths but variable internal angles. When mounted on a road vehicle, these axes of rotation run parallel to a longitudinal axis of the vehicle. The upper arm is connected on the contact wire side to the center strut via a rocker joint, which enables a rotational movement between the parallelogram plane of the rocker frame and the upper arm. The axes of rotation of the rocker joint, the elbow joint and the base joint run parallel to one another and, when mounted on a road vehicle, parallel to a transverse axis of the vehicle. The contact strips of the two contact poles are supported symmetrically to the center strut on the rocker frame. Per contact pole, for example, two contact strips arranged one behind the other can be provided, which run parallel to one another and, when mounted on a road vehicle, parallel to a transverse axis of the vehicle.

The current collector according to the invention realizes a simple, one-arm construction of the pantograph, so in addition to a lower arm, it also manages with only one upper arm, and nevertheless enables a height difference between the contact strips of the two contact poles. The contact strips are supported on the rocker frame symmetrically with respect to the center strut and thus symmetrically with respect to the upper arm of the support linkage and can move vertically due to the parallelogram mechanism of the rocker frame—namely, to the extent that the contact strips of a contact pole are lowered, the contact strips of the other contact pole are raised. The symmetrical introduction of the contact forces into the rocker frame permits a constant pressing force of the contact strips of both contact poles regardless of the lateral contact point of the contact wires on the contact strips. The design according to the invention of the current collector simplifies its assembly, its integration into a road vehicle and its maintenance. The reduced number of parts results in a lower weight and improved vibration properties of the current collector according to the invention.

In an advantageous embodiment of the current collector according to the invention, the upper arm is connected in an articulated manner to a base frame of the current collector via a pull rod and the lower arm is connected in an articulated manner to the center strut via a coupling rod in such a way that the center strut is guided in parallel in a vertically aligned manner when the contact strips are raised and lowered. The linkage consisting of the lower and upper arm as well as the pull and coupling rod form a parallel guide for the rocker frame, so that its parallelogram plane always remains vertically aligned when the current collector is being connected and disconnected.

In further advantageous embodiments of the current collector according to the invention, the contact strips are resiliently supported on the rocker frame. A suspension reduces the impact load when making contact between the contact strips and the contact wires and thus reduces the risk of spalling or breakouts from the carbon pieces of the contact strips during connection. In addition, vertical movements of the chassis, caused, for example, by braking or steering accelerations of the road vehicle or by unevenness of the roadway, are not transmitted in an unsprung manner to the contact strips in sliding contact with the contact wires. The resilient support can be formed by linearly guided spring cups between the rocker frame and the contact strips. Furthermore, leaf springs can be attached to the rocker frame, which can project laterally, for example, and on which the contact strips are supported. In addition to the vertical movement, this also results in a lateral displacement during compression which is functionally negligible due to the short spring travel of, for example, 30 mm. Furthermore, the transverse beams of the rocker frame can be designed such that they can be bent in a spring-elastic manner, so that the contact strips can perform a spring movement by bending the transverse beams by supporting them on the lateral struts.

In a further advantageous embodiment of the current collector according to the invention, a rotational movement of the transverse beam about the axes of rotation of the swivel joints of the center strut is limited by limiting means. By limiting the rotational movement, that is to say the maximum permitted angle of rotation of the transverse beams from the horizontal, the possible height difference between the contact strips of the two contact poles is limited. The adjustment of the permissible height difference between the contact poles can be shifted directly into the rocker assembly and there to different places. The limiting means may be designed as mechanical stop elements against which one or both transverse beams strike when the maximum angle of rotation is reached. Likewise, the limiting means may be integrated into one or more of the six swivel joints of the rocker frame. For reasons of redundancy, a combination of the aforementioned limiting means can also be selected. With the current collector according to the invention, a simple, direct and robust adjustment of the permitted height difference is thus possible.

In a further advantageous embodiment of the current collector according to the invention, the rocker assembly has a protective bracket which is arranged and shaped in such a way that dipping of a contact wire into a space between the two contact poles below a contact strip is prevented. The protective bracket can be mounted at its ends via in each case a bracket joint on the rocker frame or on the contact strips or on drain horns in such a way that it bridges the gap between the two contact strips of the contact poles at all height differences. Alternatively, the protective bracket can be formed by the inner drain horns themselves when these drain horns of the two contact poles overlap sufficiently in all vertical positions of the contact strips. This prevents a contact wire which leaves a carbon piece of a contact strip in the direction of the center of the vehicle during a steering maneuver of the road vehicle from falling below a contact strip due to the righting moment of the lifting drive in the space between the contact poles. Such threading of a contact wire can lead to damage to the current collector and overhead line system and subsequent accidents on the roadway as a result.

In a further advantageous embodiment of the current collector according to the invention, the rocker assembly only supports one contact strip per contact pole. Compared to the usual two contact strips arranged one behind the other in the direction of travel for each contact pole, this further simplifies the current collector according to the invention, which reduces component and assembly costs. The coupling rod can be extended by a linear joint in order to be able to adjust the position of the otherwise vertically aligned parallelogram plane of the rocker frame in the case of contact wires rising or falling with respect to the roadway or in the case of pitching movements of the road vehicle.

The invention also relates to a road vehicle with an electric or hybrid-electric drive as well as with a current collector as claimed in one of the claims 1 to 8.

Further properties and advantages of the invention will emerge from the description which follows of a preferred exemplary embodiment with reference to the drawings, in which a diagrammatic view is shown of

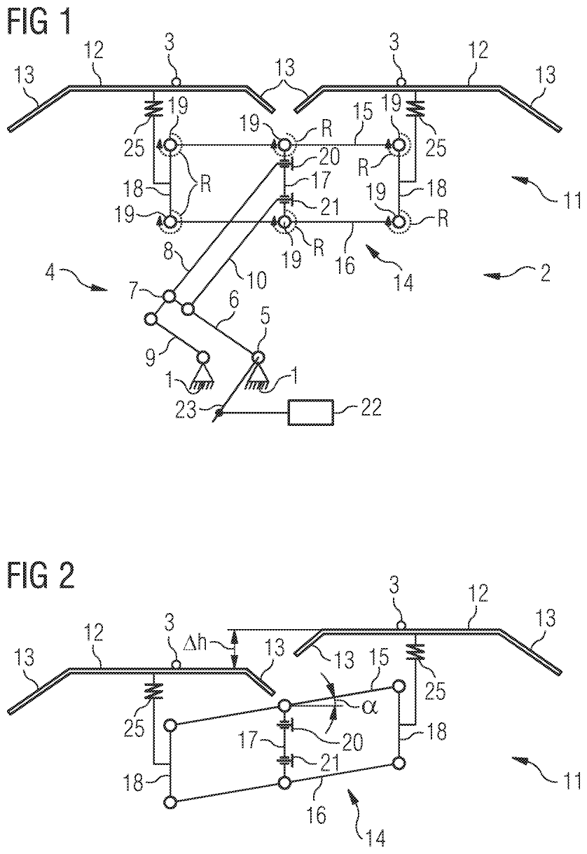

FIG. 1 A first exemplary embodiment of a current collector according to the invention,

FIG. 2 The current collector from FIG. 1 where there is a height difference between the contact strips,

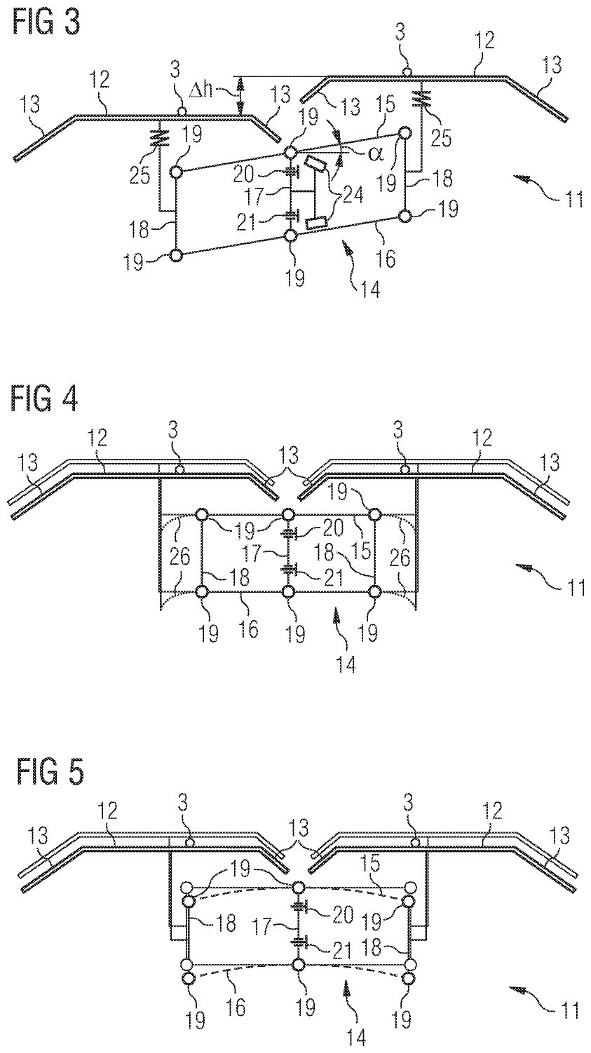

FIG. 3 A second exemplary embodiment of a current collector according to the invention with limiting elements,

FIG. 4 A third exemplary embodiment of a current collector according to the invention with leaf springs,

FIG. 5 A fourth exemplary embodiment of a current collector according to the invention with flexurally elastic transverse beams,

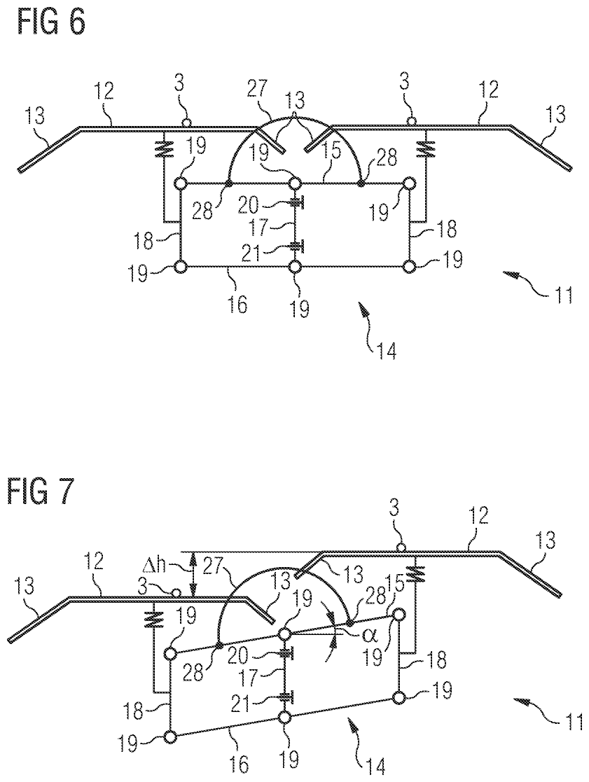

FIG. 6 A fifth exemplary embodiment of a current collector according to the invention with a protective bracket,

FIG. 7 The current collector from FIG. 6 where there is a height difference between the contact strips,

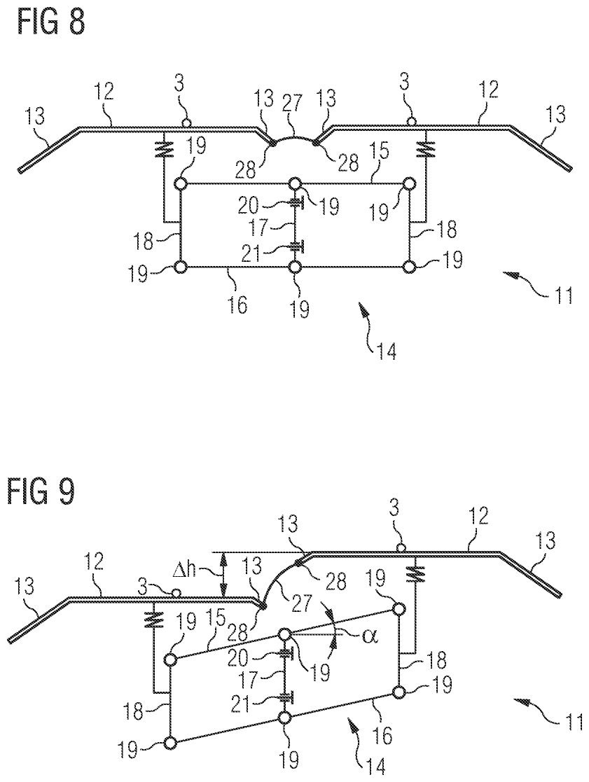

FIG. 8 A sixth exemplary embodiment of a current collector according to the invention with another protective bracket and

FIG. 9 The current collector from FIG. 8 where there is a height difference between the contact strips.

According to FIG. 1, a road vehicle 1 is equipped with a current collector 2 for feeding traction energy from a two-pole overhead line system having contact wires 3 which is designed as a supply and return conductor. The road vehicle may be a heavy commercial vehicle, such as a semi-trailer tractor or a bus, having an electric or hybrid-electric traction drive. Only one point of the road vehicle 1 connected to the chassis of the road vehicle 1, on which the current collector 2 is supported, is indicated. Of the overhead line system, only the two contact wires 3 are shown, which run via hangers on suspension cables above the electrified traffic lane of a roadway traveled by the road vehicle 1.

The current collector 2 comprises an articulated supporting rod 4 which is designed as pantograph-like semi-scissors and has a lower arm 6 which is supported on the road vehicle 1 via a base joint 5 and an upper arm 8 which is connected to the lower arm 6 via an elbow joint 7. A pull rod 9 articulates the vehicle-side end of the upper arm 8 to the road vehicle 1 or to a base frame of the current collector 2 connected thereto. A coupling rod 10 is connected in an articulated manner to the lower arm 6. The supporting rod 4 described is shown in a side view in FIG. 1 for presentation purposes, a longitudinal axis of the vehicle would thus extend from right to left here for this part of the figure.

However, for presentation purposes, the rocker assembly 11 supported by the supporting rod 4 on the contact wire side is shown in a front view in FIG. 1, a longitudinal axis of the vehicle would therefore extend perpendicular to the drawing plane for this part of the figure. The rocker assembly 11 supports only one contact strip 12 per contact pole, which are parallel to one another and transverse to the longitudinal axis of the vehicle. Each contact strip 12 comprises an elongated carbon piece with an upward-facing contact surface, which is ground by the contact wire 3 for energy transmission during travel, and at each end a downwardly bent drain horn 13.

The rocker assembly 11 has a rocker frame 14 having an upper transverse beam 15 and a lower transverse beam 16 which are arranged parallel or almost parallel to one another. The upper transverse beam 15 is connected to the lower transverse beam 16 centrally by a center strut 17 and at each end by a lateral strut 18. The center strut 17 and the lateral struts 18 are arranged parallel or almost parallel to one another and have swivel joints 19 at the six connection points, each with a rotational degree of freedom R. The six axes of rotation run parallel to one another, in FIG. 1 perpendicular to the drawing plane, so that the rocker frame 14 defines a parallelogram or almost a parallelogram. The center strut 17 is connected to the upper arm 8 via a rocker joint 20 and to the coupling rod 10 via a coupling joint 21, which enables a rotational movement of the parallelogram plane of the rocker frame 14 relative to the upper arm 8 and the coupling rod 10. The axes of rotation of the rocker joint 20, the coupling joint 21, the elbow joint 7 and the base joint 5 run parallel to one another and to the transverse axis of the vehicle.

The current collector 2 further comprises, for example, a lifting drive 22 designed as an air bellows, which is coupled, for example, to the supporting rod 4 via a bellows lever 23 in such a way that the contact strips 12 can be raised from a lower storage position to an upper contact position. The supporting rod 4 forms a parallel guide for the rocker frame 14, so that its parallelogram plane always remains vertically aligned when the rocker assembly 11 is being raised and lowered.

The contact strips 12 of the two contact poles are supported symmetrically with respect to the center strut 17 and thus symmetrically with respect to the upper arm 8 of the support linkage 4 on the lateral struts 16 of the rocker frame 14. The contact strips 12 can move vertically due to the parallelogram mechanism of the rocker frame 14 and thus adapt to height differences Δh between the contact wires 3 according to FIG. 2. For this purpose, the transverse beams 15, 16 each rotate by an angle of rotation α against the horizontal. As a result, a symmetrical introduction of the contact forces into the rocker frame 14 is made possible, which leads to a constant pressing force of the contact strips 12 of both contact poles regardless of the lateral contact point of the contact wires 3 on the contact strips 12.

The rotational movement of the transverse beams 15, 16 about the axes of rotation of the swivel joint 19 of the center strut 17 is limited by limiting means according to FIG. 3. By limiting the angle of rotation α, the possible height difference Δh between the contact strips 12 of the two contact poles is limited. The limiting means can be designed as mechanical stop elements 24 against which the transverse beams 15, 16 strike when the maximum angle of rotation α is reached.

The contact strips 12 are resiliently supported on the rocker frame in order to reduce the impact load when making contact between the contact strips 12 and the contact wires 6 and thus reduce the risk of spalling or breakouts from the carbon pieces of the contact strips 12 when connecting. According to FIG. 1 to FIG. 3 and FIG. 6 to FIG. 9, the resilient support can be formed by linearly guided spring cups 25 between the rocker frame 14 and the contact strips 12. According to FIG. 4, laterally projecting leaf springs 26, on which the contact strips 12 are supported, may also be attached to the rocker frame 14. According to FIG. 5, the transverse beams 15, 16 of the rocker frame 14 can also be designed such that they can be bent in a spring-elastic manner, so that the contact strips 12 can carry out a spring movement by bending the transverse beams 15, 16 by supporting them on the lateral struts 18.

According to FIG. 6 to FIG. 9, the rocker assembly 11 has a protective bracket 27. The protective bracket 27 can be mounted at its ends via a bracket joint 28 according to FIG. 6 and FIG. 7 on the rocker frame 14 or according to FIG. 8 and FIG. 9 on the drain horns 13 of the contact strips 12. In the case of all height differences Δh, the upwardly curved protective bracket 27 bridges the gap between the two contact strips 12. It thus prevents the dipping of a contact wire 3 into a space between the two contact poles below a contact strip 12. This prevents a contact wire 3 which leaves the carbon piece of a contact strip 12 in the direction of the gap or space during a steering maneuver of the road vehicle 1 from falling into the space below a contact strip 12 due to the righting moment of the lifting drive 22. This prevents damage to the current collector 2 and the overhead line system by threading a contact wire 3 into the space.

1-9. (canceled)

10. A current collector for an electrically or hybrid electrically powered road vehicle for feeding electrical traction energy from a two-pole overhead line system with one contact wire for each contact pole, the current collector comprising:
an articulated supporting rod formed as a pantograph with a lower arm, an upper arm, and an elbow joint connecting said lower arm to said upper arm;
said supporting rod having a contact wire side supporting a rocker assembly with at least one contact strip for each contact pole and a vehicle side with a base joint for support on the road vehicle;
said rocker assembly having a rocker frame with an upper transverse beam, a lower transverse beam arranged parallel to said upper transverse beam, a center strut, and two lateral struts;
said center strut centrally connecting said upper transverse beam to said lower transverse beam and said lateral struts connecting said upper and lower transverse beams at each end thereof, said lateral struts extending parallel to said center strut and being pivotally mounted on swivel joints having mutually parallel rotation axes;
said upper arm being connected on the contact wire side to said center strut via a rocker joint;
said rocker joint, said elbow joint, and said base joint have axes of rotation running parallel to one another; and
said contact strips of said contact poles being supported symmetrically with respect to said center strut on said rocker frame; and
a lifting drive coupled to said supporting rod and configured for lifting said contact strips from a lower storage position into an upper contact position.

11. The current collector according to claim 10, wherein said upper arm is connected and articulated at the road vehicle via a pull rod and said lower arm is connected and articulated at said center strut via a coupling rod, to guide said center strut in parallel in a vertically aligned manner when lifting said contact strips.

12. The current collector according to claim 10, which comprises linearly guided spring cups resiliently supporting said contact strips on said rocker frame.

13. The current collector according to claim 10, which comprises leaf springs disposed to resiliently support said contact strips on said rocker frame.

14. The current collector according to claim 10, wherein said contact strips are supported on said lateral struts of said rocker frame and said transverse beams are resiliently flexible beams.

15. The current collector according to claim 10, which comprises stop elements disposed to limit a rotational movement of said transverse beams about said swivel joints of said center strut.

16. The current collector according to claim 10, wherein said rocker assembly comprises a protective bracket which is arranged and shaped to prevent a dipping of a contact wire into a space between said contact poles below a contact strip.

17. The current collector according to claim 10, wherein said rocker assembly is configured to only supports one contact strip per contact pole.

18. A road vehicle, comprising an electric or hybrid-electric drive and a current collector according to claim 10.
